(19) United States
(12) Patent Application Publication
(10) Pub. No.: US 2017/0164010 A1
(43) Pub. Date: Jun. 8, 2017

(54) METHOD AND DEVICE FOR GENERATING AND PLAYING VIDEO

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Jijian ZHENG, Tianjin (CN)

(21) Appl. No.: 15/246,451

(22) Filed: Aug. 24, 2016

Related U.S. Application Data
(63) Continuation of application No. PCT/CN2016/089267, filed on Jul. 7, 2016.

(30) Foreign Application Priority Data
Dec. 3, 2015 (CN) 201510883184.5

(51) Int. Cl. H04N 21/2187; H04N 21/845; H04N 21/439; H04N 21/854; H04N 21/433; H04N 5/77; H04N 21/84

(52) U.S. Cl. CPC H04N 21/2187; H04N 5/772; H04N 21/845; H04N 21/84; H04N 21/85406; H04N 21/4334; H04N 21/439

(57) ABSTRACT

Embodiments of the present disclosure disclose a method and a device for generating and playing a video, The method for generating a video comprises: collecting at least two live video streams by a server and assigning identifiers to the live video streams, respectively; integrating, the live video streams according to the identifiers to generate an integrated live video stream; assigning a resource address to the integrated live video stream; feeding back the corresponding integrated live video stream to a player after receiving a request for the resource address. A plurality of video streams can be transmitted simultaneously by means of the integrated live video stream, and thus can be played synchronously.

### CROSS-REFERENCE TO RELATED APPLICATIONS

The present disclosure is a continuation of International Application No. PCT/CN2016/089267 filed on Jul. 7, 2015 which is based upon and claims priority to Chinese Patent Application No. 201510883184.5, entitled “METHOD AND DEVICE FOR GENERATING AND PLAYING VIDEO”, filed on Dec. 3, 2015, and the entire contents of all of which are incorporated herein by reference.

### FIELD OF TECHNOLOGY

The present disclosure generally relates to the technical field of Mobile Internet, and in particular, to a method for playing a video, a method for generating a video, a player device and a device for generating a video.

### BACKGROUND

In general sports events or other live programs, a plurality of cameras are often arranged to comprehensively show the progress and details of the events. During live broadcasting, images can be switched in real time; however, if a user wants to display a plurality of images simultaneously on a device thereof, such as a mobile device or a television device, the programs need to be post-processed independently and then broadcasted to the user.

The user has found out in the process of implementing the present disclosure that mobile devices or television devices now are all capable of simultaneously playing a plurality of video streams, which is generally realized by starting a plurality of players. However, due to different downloading speeds caused by network jittering or for other reasons such as time difference of starting a plurality of players and the like, a problem of inconsistent timestamps of a plurality of video streams may happen; for example, one video stream is slower several seconds than another video.

### SUMMARY

The technical problems to be solved by embodiments of the present disclosure is to disclose a method for playing a video, which is intended to solve the problem that a plurality of video streams cannot be played simultaneously.

An embodiment of the present disclosure discloses a video generating method.

Correspondingly, an embodiment of the present disclosure discloses a player device and a video generating device to ensure the realization and application of the method above.

To solve the problem above, an embodiment of the present disclosure further discloses a method for playing a video, at an electronic device, including: obtaining an integrated live video stream by a player according to a received resource address, wherein the integrated live video stream comprises at least two live video streams; separating the integrated live video stream by the player using a multistage parser into live video streams corresponding to identifiers one to one; simultaneously playing the live video streams corresponding to the identifiers.

An embodiment of the present disclosure further discloses a player device, including: at least one processor; and a memory communicably connected with the at least one processor for storing instructions executable by the at least one processor, wherein execution of the instructions by the at least one processor causes the at least one processor to: obtain an integrated live video stream according to a received resource address, wherein the integrated live video stream comprises at least two live video streams; separate the integrated live video stream using a multistage parser into live video streams corresponding to identifiers one to one; simultaneously play the live video streams corresponding to the identifiers.

An embodiment of the present disclosure discloses a non-transitory computer readable medium storing executable instructions that, when executed by an electronic device, cause the electronic device to: obtain an integrated live video stream according to a received resource address, wherein the integrated live video stream comprises at least two live video streams; separate the integrated live video stream using a multistage parser into live video streams corresponding to identifiers one to one; simultaneously play the live video streams corresponding to the identifiers.

Compared with the prior art, the embodiments of the present disclosure have the following advantages:
the present disclosure provides a method for generating and playing a video: a server collects at least two live video streams and assigns identifiers to the live video streams, respectively. The live video streams are integrated according to the identifiers to generate an integrated live video stream. A resource address is assigned to the integrated live video stream, and the corresponding integrated live video stream is fed back to a player after receiving a request for the resource address. The player obtains the integrated live video stream according to the received resource address, separates the integrated live video stream using a multistage parser into the live video streams corresponding to the identifiers one to one, and simultaneously plays the live video streams corresponding to the identifiers. As a result, the problem of inconsistent timestamps of a plurality of live video streams is effectively avoided; a plurality of video streams can be transmitted simultaneously by means of the integrated live video stream and therefore, a plurality of live video streams can be played simultaneously.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of a method for playing a video in accordance with some embodiments.

FIG. 2 is a step flow diagram of an embodiment of a method for generating a video in accordance with some embodiments.

FIG. 3 is a step flow diagram of an embodiment of a method for generating and playing a video in accordance with some embodiments.

FIG. 4 is a step flow diagram of an embodiment of a method for partitioning and integrating video streams in a third embodiment in accordance with some embodiments.

FIG. 5 is a structural block diagram of an embodiment of a player device according to a fourth embodiment in accordance with some embodiments.

FIG. 6 is a structural block diagram of another embodiment of a player device according to the fourth embodiment in accordance with some embodiments.

FIG. 7 is a structural block diagram of an embodiment of a device for generating a video according to a fifth embodiment in accordance with some embodiments.

FIG. 8 is a structural block diagram of another embodiment of a device for generating a video according to the fifth embodiment in accordance with some embodiments.

FIG. 9 schematically shows a block diagram of an electronic device for executing a method in accordance with some embodiments.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, but not all embodiments. On the basis of the embodiments in the present disclosure, all the other embodiments obtained by people skilled in the art without creative work should fall into the scope of protection of the present disclosure.

One core concept of the embodiments of the present disclosure is that a method for generating and playing a video is provided: a server collects at least two live video streams and assigns identifiers to the live video streams, respectively. The live video streams are integrated according to the identifiers to generate an integrated live video stream. A resource address is assigned to the integrated live video stream, and the corresponding integrated live video stream is fed back to a player after receiving a request for the resource address. The player obtains the integrated live video stream according to the received resource address, separates the integrated live video stream using a multistage parser into the live video streams corresponding to the identifiers one to one, and simultaneously plays the live video streams corresponding to the identifiers. As a result, the problem of inconsistent timestamps of a plurality of live video streams is effectively avoided; a plurality of video streams can be transmitted simultaneously by means of the integrated live video stream, and therefore, a plurality of live video streams can be played simultaneously.

### A First Embodiment

A method for playing a video of an embodiment of the present disclosure will be introduced in detail.

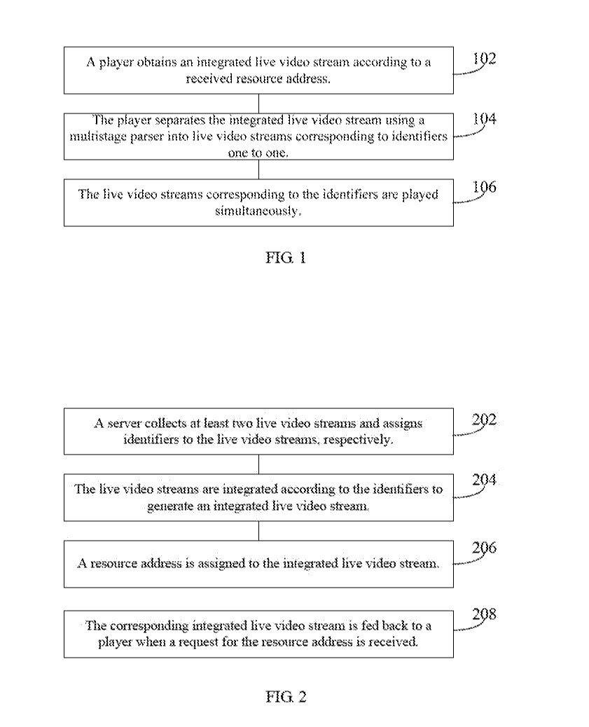

By referring to FIG. 1, which shows the step flow diagram of the embodiment of the method for playing a video of the present disclosure, the method may specifically include the steps as follows.

Step S102, a player obtains an integrated live video stream according to a received resource address, wherein the integrated live video stream includes at least two live video streams.

When a live video is displayed on a device like a mobile device or a television device, in order to get live broadcasting contents more comprehensively and accurately, usually, a plurality of live video streams may be played simultaneously. In this embodiment of the present disclosure, in order to ensure consistent playing timestamps of at least two live video streams, the live video streams are integrated in advance to generate the integrated live video stream; then, the integrated live video stream obtained by the player is generated by integrating at least two live video streams, thereby ensuring consistent network transmission conditions of the at least two live video streams from a server to the player, such as a transmission rate, network quality and the like. The integrated live video stream is generated by the server and stored in a corresponding resource address. The player may send a request for obtaining the resource address to the server to receive the integrated live video stream corresponding to the resource address.

Step S104, the player separates the integrated live video stream using a multistage parser into live video streams corresponding to identifiers one to one.

As different live video streams need to be played independently, the integrated live video stream needs to be separated into individual live video streams therein. The player in this embodiment of the present disclosure includes the multistage parser. Typically, a common parser is intended to parse a video stream into a video file and an audio file; therefore, different video streams need to be transmitted separately. The multistage parser is used to parse the integrated live video stream. That is, by using the multistage parser, the individual live video streams can be separated out of the integrated live video stream first, and further, each live video stream is separated into a video file and an audio file; in this way, multistage parsing on the integrated live video stream is realized. When the server integrates at least two live video streams, each live video stream is assigned with one identifier. Hence, in this embodiment of the present disclosure, when the integrated live video stream is separated, analysis is carried out according to the identifiers, and one live video stream is separated out for each identifier.

Step S106, the live video streams corresponding to the identifiers are played simultaneously.

The player provided in this embodiment of the present disclosure is capable of displaying a plurality of windows at the same time; the display of a stream of images of the live video stream corresponding to one identifier is realized in each window. The audios of the live video streams are integrated, and the integrated audio stream and the corresponding live video streams are played simultaneously. Therefore, the problem of inconsistent timestamps of a plurality of video streams caused by different downloading speeds due to network jittering or other reasons such as time difference of starting a plurality of players and the like can be effectively avoided; as a result, consistent transmission conditions of the video streams is guaranteed, and simultaneous playing of a plurality of live video streams is realized.

In conclusion, the player obtains the integrated live video stream according, to the received resource address, separates the integrated live video stream using the multistage parser into the live video streams corresponding to the identifiers one to one, and simultaneously plays the live video streams corresponding to the identifiers. Therefore, the problem of inconsistent timestamps of a plurality of video streams caused by different downloading speeds due to network jittering or other reasons such as time difference of starting a plurality of players and the like can be effectively avoided; as a result, consistent transmission conditions of the video streams is guaranteed, and simultaneous playing of a plurality of live video streams is realized.

### A Second Embodiment

On the basis of the above embodiment, a method for generating a video by integrating a plurality of video streams will be introduced below in detail.

By referring to FIG. 2, which shows the step flow diagram of the method for generating a video of the present disclosure, the method may specifically include the steps as follows.

Step S202, a server collects at least two live video streams and assigns identifiers to the live video streams, respectively.

In order to guarantee synchronization of a plurality of live video streams played simultaneously, the server may collect at least two live video streams for integration. For the purpose of subsequently differentiating different live video streams, an identifier may be assigned to each live video stream, such as a process identifier (PID).

Step S204, the live video streams are integrated according to the identifiers to generate an integrated live video stream.

For the sake of ensuring consistent network transmission conditions of at least two live video streams from the server to a player, the server puts the at least two live video streams into a certain order and integrates them into one video stream for transmission. Different identifiers correspond to different live video streams; the live video streams corresponding to the identifiers are integrated according to the identifiers. For example, the at least two live video streams are connected in series to generate the integrated live video stream.

Step S206, a resource address is assigned to the integrated live video stream.

After the server generates the integrated live video stream, the video stream is stream and needs to be assigned with a resource address so that it can be sought subsequently. The resource address herein includes a Uniform Resource Locator (URL) for indicating a position of a live video stream and an access method thereto.

Step S208, the corresponding integrated live video stream is fed back to a player when a request for the resource address is received.

When a player requires playing a live video stream, it usually needs to send a request for obtaining the resource address to the server. The server receives the request, and then finds out the integrated live video stream according to the resource address and feeds back the live video stream to the player.

In conclusion, the server collects at least two live video streams and assigns identifiers to the live video streams, respectively. The live video streams are integrated according to the identifiers to generate the integrated live video stream. The resource address is assigned to the integrated live video stream, and the corresponding integrated live video stream is fed back to the player after receiving the request for the resource address. The player obtains the integrated live video stream according to the received resource address, separates the integrated live video stream using the multistage parser into the live video streams corresponding to the identifiers one to one, and simultaneously plays the live video streams corresponding to the identifiers. Therefore, the problem of inconsistent timestamps of a plurality of video streams caused by different downloading speeds due to network jittering or other reasons such as time difference of starting a plurality of players and the like can be effectively avoided; as a result, consistent transmission conditions of the video streams is guaranteed, and simultaneous playing of a plurality of live video streams is realized.

### A Third Embodiment

The method for playing a video and the method for generating a video are discussed in the above embodiments, respectively. A method for generating and playing a video will be discussed as a whole in this embodiment.

Step S302, a server collects at least two live video streams and assigns identifiers to the live video streams, respectively.

In order to guarantee synchronization of a plurality of live video streams played simultaneously, the server may collect at least two live video streams for integration. For the purpose of subsequently differentiating different live video streams, an identifier may be assigned to each live video stream, such as a process identifier (PID).

Step S304, the live video stream corresponding to each identifier is partitioned to determine video segments corresponding to each identifier.

Step S306, the video segments corresponding to the identifiers are alternately sorted according to a preset order and integrated into one live video stream, wherein adjacent video segments in the live video stream have different identifiers.

For the sake of convenient network transmission, the live video stream corresponding to each identifier can be partitioned individually; it should be guaranteed that each live video stream has the same number of video segments after being partitioned; each video segment still has the identifier the same as that of the live video stream that the video segment belongs to. As described above, in order to ensure consistent network transmission rate of at least two live video streams from the server to the player, the at least two live video streams need to be put into a certain order by the server and integrated into one video stream for transmission. The video segments corresponding to the identifiers may also be alternately sorted according to the order herein and thus integrated into one live video stream.

In this process, in order to prevent wrong connection positions of the separate different video segments of the live video stream, a preset number of blank frames may also be inserted between the different video segments after the alternate sorting of the video segments corresponding to the identifiers according to the preset order. Alternatively, in the process of alternately sorting the video segments, part of blank frames is remained after one video segment is added, and then next video segment is added. Therefore, the video segments are separated by the blank frames in the integrated live video stream.

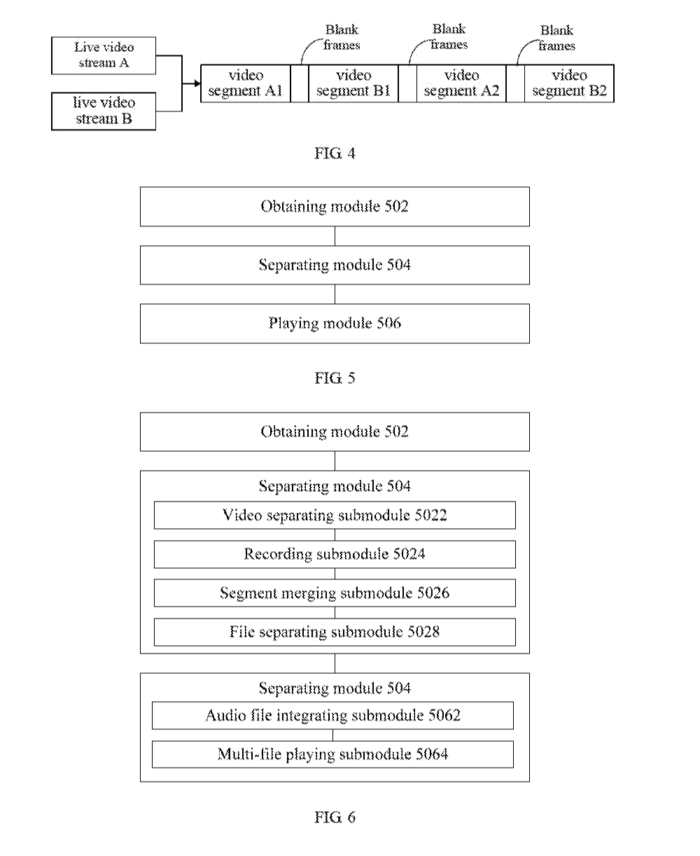

As show in FIG. 4, there are two live video streams, of which the identifiers are A and B, respectively. The live video stream A is partitioned into video segment A1 and video segment A2, while the live video stream B is partitioned into video segment B1 and video segment B2. The order of alternately sorting the video segments corresponding to the identifiers is video segment A1, video segment B1, video segment A2, and video segment B2; after the four video segments are sorted alternately, a preset number of blank frames is inserted between video segments A1 and B1, B1 and A2, and A2 and B2. Alternatively, in the process of alternately sorting the four video segments, a preset number of blank frames is remained after video segment A1 is added, and then video segment B1 is added and the preset number of blank frames is also retained. In accordance with the rule, video segment A2 and video segment B2 are orderly added and integrated into one live video stream.

Step S308, a resource address is assigned to the integrated live video stream.

After the server generates the integrated live video stream, the video stream is stream and needs to be assigned with a resource address so that it can be sought subsequently. The resource address herein includes a Uniform Resource Locator (URL) for indicating a position of a live video stream and an access method thereto.

Step S310, the corresponding integrated live video stream is fed back to a player when a request for the resource address is received.

When a player requires playing a live video stream, it usually needs to send a request for obtaining the resource address to the server. The server receives the request, and then finds out the integrated live video stream according to the resource address and feeds back the live video stream to the player.

Step S312, the player obtains the integrated live video stream according to the received resource address, wherein the integrated live video stream includes at least two live video streams.

When the player is going to simultaneously play a plurality of live video streams, it needs to obtain an integrated live video stream from the server. The player sends the request for obtaining the resource address to the server and then receives the integrated live video stream fed back by the sever, wherein the integrated live video stream includes at least two live video streams.

Step S314, the player separates the integrated live video stream using a multistage parser in sequence into live video streams corresponding to identifiers one to one.

Hereafter, the corresponding live video stream can be generated according to the video segments corresponding to each identifier, wherein the sort order of the video segments can be recorded first; thus, the operation of generating the corresponding live video stream according to the video segments corresponding to each identifier includes: merging the video segments corresponding to each identifier according to the sort order to generate the live video stream corresponding to the identifier. This process is specifically described as follows: Step S316, the sort order of the video segments is recorded.

Step S318, the video segments corresponding to each identifier are merged according to the sort order to generate the live video stream corresponding to the identifier.

The player in this embodiment of the present disclosure includes the multistage parser, for example, multistage Demuxer. The player separates the integrated live video stream using the multistage parser, such as differentiating different video segments in conjunction with the blank frames and different identifiers; a plurality of video segments corresponding to different identifiers are separated out in sequence according to the original sort order, and then the video segments corresponding to each identifier to generate the corresponding live video stream. Or, after the a plurality of video segments corresponding to different identifiers are separated out in sequence according to the original sort order and before the video segments corresponding to each identifier to generate the corresponding live video stream, the sort order of the video segments is recorded first, and the video segments corresponding to each identifier are merged according to the sort order to generate the live video stream corresponding to the identifier.

As shown in FIG. 4, the video segments in the integrated live video stream are sorted as: video segment A1, video segment B1, video segment A2, and video segment B2; a preset number of blank frames is inserted between different video segments. When the player separates the integrated live video stream using the multistage parser, the first video segment A1 is separated out according to the identifier first, and then the blank frames without identifier are skipped over and the video segment B1 is separated out; by this analogy, video segment A2 and video segment B2 are separated out. The sort order of the video segments is recorded, and the video segments having the same identifier are merged according to the original sort order. That is, the video segments are merged according to the order of video segment A1 ahead and video segment A2 behind, and the order of video segment B1 ahead and video segment B2 behind. The live video streams corresponding to the identifiers thus can be generated.

Step S320, the live video stream corresponding to each identifier is separated according to file formats to obtain a video file and an audio file included in each live video stream.

Step S322, the audio files of the live video streams corresponding to the identifiers are integrated to generate an integrated audio file.

Step S324, the video files of the live video streams corresponding to the identifiers and the integrated audio file are played simultaneously.

Each video stream includes a video file and an audio file, which can be separated according to the file formats. The video file is transmitted to a display for displaying a stream of images, while the audio file is transmitted to a speaker, thereby realizing playing of the video stream.

In this embodiment of the present disclosure, the live video stream corresponding to each identifier can be separated according to the file formats into the video file and the audio file included therein. When at least two video streams are going to be played on the same player, it means that at least two video files and at least two audio files are displayed. The player provided in this embodiment of the present disclosure is capable of displaying a plurality of windows at the same time; the display of a stream of images of the live video stream corresponding to one identifier is realized in each window. In order to avoid a voice disorder of a plurality of audio file, the audio files of the live video streams corresponding to the identifiers need to be integrated to generate the integrated audio files. The video files of the live video streams corresponding to the identifiers are transmitted to the display, while the integrated audio file is transmitted to the speaker, and the video files and the integrated audio files are played simultaneously; therefore, simultaneous playing of a plurality of live video streams is realized.

In conclusion, the server partitions the live video stream corresponding to each identifier into a plurality of video segments, and alternately sorts the video segments corresponding to the identifiers according to the preset order and integrates them into one live video stream for transmitting to the player; the player parses the integrated live video streams to realize simultaneous playing of a plurality of live video streams. Meanwhile, convenience is provided for network transmission between the server and the player.

It needs to be noted that in regard to the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are preferred embodiments, and the actions involved therein are not necessary for the embodiments of the present disclosure.

### A Fourth Embodiment

By referring to FIG. 5, which shows the structural block diagram of the embodiment of the player device according to the fourth embodiment of the present disclosure, the player device may specifically include the following modules: an obtaining module 502, a separating module 504 and a playing module 506.

The obtaining module 502 is configured to obtain an integrated live video stream according to a received resource address, wherein the integrated live video stream includes at least two live video streams.

The separating module 504 is configured to separate the integrated live video stream using a multistage parser into live video streams corresponding to identifiers one to one.

The playing module 506 is configured to simultaneously play the live video streams corresponding to the identifiers.

In conclusion, the player obtains the integrated live video stream according to the received resource address, separates the integrated live video stream using the multistage parser into the live video streams corresponding to the identifiers one to one, and simultaneously plays the live video streams corresponding to the identifiers. Therefore, the problem of inconsistent timestamps of a plurality of video streams caused by different downloading speeds due to network jittering or other reasons such as time difference of starting a plurality of players and the like can be effectively avoided; as a result, consistent transmission conditions of the video streams is guaranteed, and simultaneous playing of a plurality of live video streams is realized.

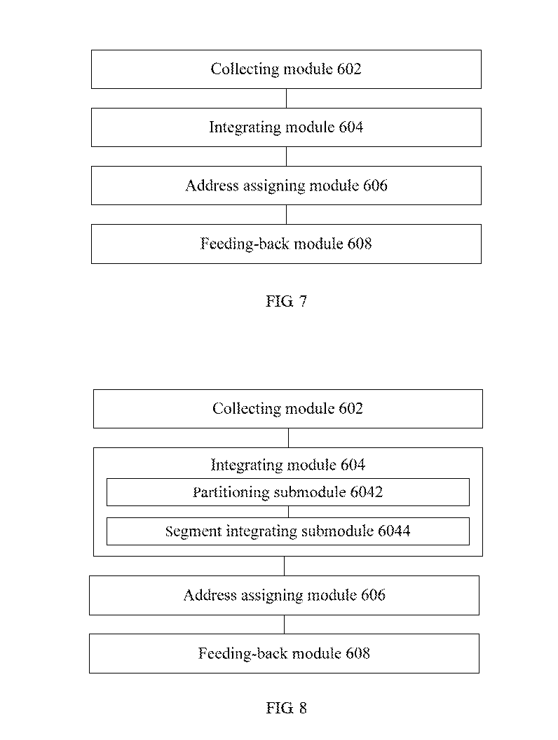

By referring to FIG. 6, which shows the structural block diagram of another embodiment of the player device according to the fourth embodiment of the present disclosure, the player device may specifically include the following modules: an obtaining module 502, a separating module 504 and a playing module 506, wherein

The obtaining module 502 is configured to obtain an integrated live video stream according to a received resource address, wherein the integrated live video stream includes at least two live video streams.

The separating module 504 is configured to separate the integrated live video stream by the player using a multistage parser into live video streams corresponding to identifiers one to one.

In an optional embodiment of the present disclosure, the separating module 502 includes: a video separating submodule 5022 and a segment merging submodule 5026, wherein the video separating submodule 5022 is configured to separate the integrated live video stream by the player using the multistage parser to obtain a plurality of video segments corresponding to different identifiers in sequence. The segment merging submodule 5026 is configured to generate corresponding live video streams according to the video segments corresponding to the identifiers.

In another optional embodiment of the present disclosure, the separating module 502 also includes: a recording submodule 5024 configured to record sort order of the video segments. The segment merging submodule 5026 is configured to merge the video segments corresponding to each identifier according to the sort order to generate the live video stream corresponding to the identifier.

The separating module 502 also includes: a file separating submodule 5028 configured to separate the live video stream corresponding to each identifier according to file formats to obtain a video file and an audio file included in each live video stream.

The playing module 506 is configured to simultaneously play the live video streams corresponding to the identifiers.

The playing module 506 includes: an audio file integrating submodule 5062 and a multi-file playing submodule 5064.

The audio file integrating submodule 5062 is configured to integrate the audio files of the live video streams corresponding to the identifiers to generate an integrated audio file.

The multi-file playing submodule 5064 is configured to simultaneously play the video files of the live video streams corresponding to the identifiers, and the integrated audio file.

In conclusion, a server partitions the live video stream corresponding to each identifier into a plurality of video segments, and alternately sorts the video segments corresponding to the identifiers according to the preset order and integrates them into one live video stream for transmitting to the player; the player parses the integrated live video streams to realize simultaneous playing of a plurality of live video streams. Meanwhile, convenience is provided for network transmission between the server and the player.

### A Fifth Embodiment

By referring to FIG. 7, which shows the structural block diagram of an embodiment of the device for generating a video according to the fifth embodiment of the present disclosure, the device may specifically include the following modules: a collecting module 602, an integrating module 604, an address assigning module 606, and a feeding-back module 608.

The collecting module 602 is configured to collect at least two live video streams by a server and assigning identifiers to the live video streams, respectively.

The integrating module 604 is configured to integrate the live video streams according to the identifiers to generate an integrated live video stream.

The address assigning module 606 is configured to assign a resource address to the integrated live video stream.

The feeding-back module 608 is configured to feed back the corresponding integrated live video stream to a player after receiving a request for the resource address.

In conclusion, a server collects at least two live video streams and assigns identifiers to the live video streams, respectively. The live video streams are integrated according to the identifiers to generate the integrated live video stream. The resource address is assigned to the integrated live video stream, and the corresponding integrated live video stream is fed back to a player after receiving the request for the resource address. The player obtains the integrated live video stream according to the received resource address, separates the integrated live video stream using a multistage parser into the live video streams corresponding to the identifiers one to one, and simultaneously plays the live video streams corresponding to the identifiers. Therefore, the problem of inconsistent timestamps of a plurality of video streams caused by different downloading speeds due to network jittering or other reasons such as time difference of starting a plurality of players and the like can be effectively avoided; as a result, consistent transmission conditions of the video streams is guaranteed, and simultaneous playing of a plurality of live video streams is realized.

By referring to FIG. 8, which shows the structural block diagram of another embodiment of the device for generating a video according to the fifth embodiment of the present disclosure, the device may specifically include the following modules: a collecting module 602, an integrating module 604, an address assigning module 606, and a feeding-back module 608.

The collecting module 602 is configured to collect at least two live video streams by a server and assigning identifiers to the live video streams, respectively.

The integrating module 604 is configured to integrate the live video streams according to the identifiers to generate an integrated live video stream.

In an optional embodiment of the present disclosure, the integrating module 604 includes: a partitioning submodule 6042 and a segment integrating submodule 6044.

The partitioning submodule 6042 is configured to partition the live video stream corresponding to each identifier to determine video segments corresponding to each identifier.

The segment integrating submodule 6044 is configured to alternately sort the video segments corresponding to the identifiers according to a preset order and integrate the video segments into one live video stream, wherein adjacent video segments in the live video stream have different identifiers.

The segment integrating submodule 6044 therein is further configured to insert a preset number of blank frames between different video segments.

The address assigning module 606 is configured to assign a resource address to the integrated live video stream.

The feeding-back module 608 is configured to feed back the corresponding integrated live video stream to a player after receiving a request for the resource address.

In conclusion, a server partitions the live video stream corresponding to each identifier into a plurality of video segments, and alternately sorts the video segments corresponding to the identifiers according to the preset order and integrates them into one live video stream for transmitting to the player; the player parses the integrated live video streams to realize simultaneous playing of a plurality of live video streams. Meanwhile, convenience is provided for network transmission between the server and the player.

In regard to the device embodiments, they are just simply described as being substantially similar to the method embodiments, and the correlations therebetween just refer to part of descriptions of the method embodiments.

Each embodiment in the description is described in a progressive manner. Descriptions emphasize on the differences of each embodiment from other embodiments, and same or similar parts of various embodiments just refer to each other

A person skilled in the art should understand that the embodiments of the present disclosure may be provided as methods, devices, or computer program products. Hence, the embodiments of the present disclosure may be in the form of complete hardware embodiments, complete software embodiments, or a combination of embodiments in software and hardware aspects. Moreover, the embodiments of the present disclosure may be in the form of computer program products executed on one or more computer-readable storage mediums containing therein computer-executable program codes (including but not limited to a magnetic disk memory, a CD-ROM, an optical memory, etc.).

Embodiments of the present disclosure further provide a non-volatile computer-readable storage medium, the non-volatile computer-readable storage medium is stored with computer executable instructions which are configured to perform any of the embodiments described above of the method for playing a video.

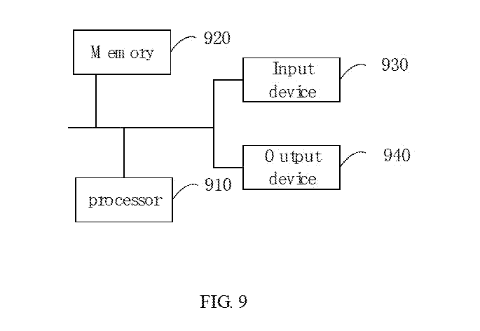

FIG. 9 illustrates a block diagram of an electronic device for executing the method according the disclosure, such as an application server. As shown in FIG. 9, the electronic device includes:
one or more processors 910 and memories 920, in FIG. 9, one processor 910 is taken as an example.

The electronic device for executing the method for playing the video may include: an input device 930 and an output device 940.

The processor 910, the memory 920, the input device 930 and the output device 940 are connected through buses or other connecting ways. In FIG. 9, a bus connection is taken as an example.

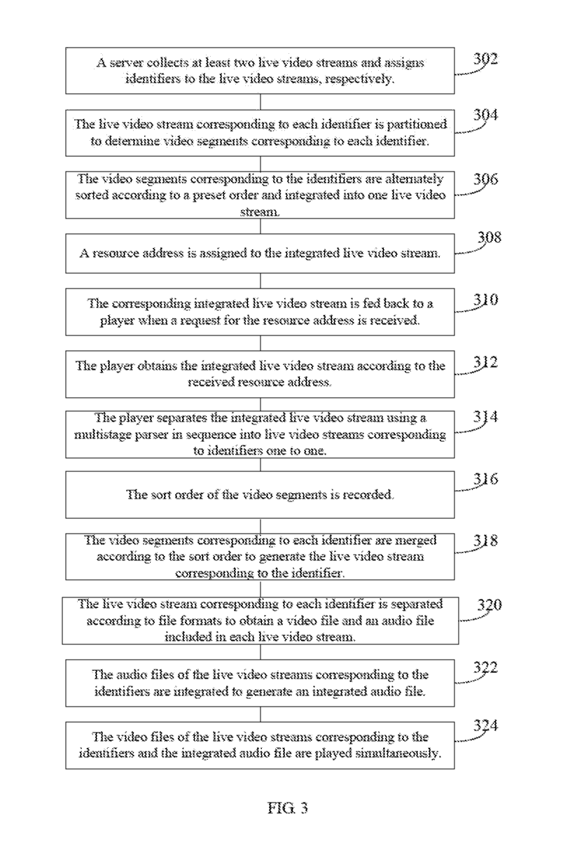

The memory 920 is a non-transitory computer readable storage medium which may be used to store non-transitory software program, non-transitory computer-executable program and modules such as the program instructions/modules (such as the parsing module 302, the playing module 304, and the switching module 306 shown in FIG. 3) corresponding to the method for playing the video according to the embodiment of the present disclosure. The processor 910 executes various functions and applications of the electronic device and performs data processing by operating the non-transitory software programs, instructions and modules stored in the memory 920, that is, executes the method for playing the video according to the method embodiments above.

The memory 920 may include a program storage section and a data storage section. Wherein the program storage section may store operating system and application needed by at least one function, and the data storage section may store the established data according to the device for adjusting the video. In addition, the memory 920 may include a high-speed random access memory, and may also include a non-transitory memory such as at least a disk memory device, flash memory device or other non-transitory solid-state storage devices. In some embodiments, the memory 920 may include a remote memory away from the processor 910. The remote memory may be connected to the device for adjusting the video via network. The network herein may include Internet, interior network in a company, local area network, mobile communication network and the combinations thereof.

The input device 930 may receive input numbers or characteristics information, and generate key signal input relative to the user setting and function control of the device for adjusting the video. The output device 940 may include display devices such as a screen.

The one or more modules are stored in the memory 920, when executed by the one or more processors 910, the methods for playing the video in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

The embodiments of the present disclosure are described with reference to the flow diagrams and/or the block diagrams of the method, a terminal device (system), and the computer program product(s) according to the embodiments of the present disclosure. It should be appreciated that computer program commands may be adopted to implement each flow and/or block in each flow diagram and/or each block diagram, and a combination of the flows and/or the blocks in each flow diagram and/or each block diagram. These computer program commands may be provided to a universal computer, a special purpose computer, an embedded processor or a processor of another programmable data processing terminal equipment to generate a machine, such that the commands executed by the computer or the processor of another programmable data processing terminal equipment create a device for implementing functions specified in one flow nr multiple flows of each flow diagram and/or one block or multiple blocks of each block diagram.

These computer program commands may also be stored in a computer-readable memory that is capable of guiding the computer or another programmable data processing terminal equipment to work in a specified mode, such that the commands stored in the computer-readable memory create a manufacture including a command device for implementing functions specified in one flow or multiple flows of each flow diagram and/or one block or multiple blocks of each block diagram.

Further, these computer program commands may be loaded on the computer or another programmable data processing terminal equipment, such that a series of operation steps are executed on the computer or another programmable data processing terminal equipment to generate processing implemented by the computer; in this way, the commands executed on the computer or another programmable data processing terminal equipment provide steps for implementing functions specified in one flow or multiple flows of each flow diagram and/or one block or multiple blocks of each block diagram.

The electronic device in embodiment of the present disclosure may have various types, which include but are not limited to:
(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;
(2) an ultra portable personal computing device belonging to personal computer scope, which has computing and processing ability and has mobile internet characteristic. This type of terminals include personal digital assistant (PDA) devices, mobile internee device (MID) devices and ultra mobile personal computer (UMPC) devices, such as iPad;
(3) a portable entertainment device which may display and play multi-media contents. This type of devices include audio players, video players (such as an iPod), handheld game players, e-books, intelligent toy, and portable vehicle-mounted navigation devices;
(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;
(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure, those modifications or replacement and the corresponding technical solutions do not depart from the spirit and scope of the technical solutions of the above embodiments of the present disclosure.

What is claimed is:

1. A method for playing a video, comprising:
at an electronic device:
obtaining an integrated live video stream by a player according to a received resource address, wherein the integrated live video stream comprises at least two live video streams;
separating the integrated live video stream by the player using a multistage parser into live video streams corresponding to identifiers one to one;
simultaneously playing the live video streams corresponding to the identifiers.

2. The method according to claim 1, wherein the step of separating the integrated live video stream by the player using the multistage parser into the live video streams corresponding to the identifiers one to one comprises:
separating the integrated live video stream by the player using the multistage parser to obtain a plurality of video segments corresponding to different identifiers in sequence;
generating corresponding live video streams according to the video segments corresponding to the identifiers.

3. The method according to claim 2, before generating the corresponding live video streams according to the video segments corresponding to the identifiers, further comprising:
recording a sort order of the video segments;
wherein the step of generating the corresponding live video streams according to the video segments corresponding to the identifiers comprises:
merging the video segments corresponding to each identifier according to the sort order to generate the live video stream corresponding to the identifier.

4. The method according to claim 2, after separating out the live video streams corresponding to the identifiers one to one, the method further comprising:
separating the live video stream corresponding to each identifier according to file formats to obtain a video file and an audio file included in each live video stream.

5. The method according to claim 3, after separating out the live video streams corresponding to the identifiers one to one, the method further comprising:
separating the live video stream corresponding to each identifier according to file formats to obtain a video file and an audio file included in each live video stream.

6. The method according to claim 4, wherein the step of simultaneously playing the live video streams corresponding to the identifiers comprises:
integrating the audio files of the live video streams corresponding to the identifiers to generate an integrated audio file;
simultaneously playing the video files of the live video streams corresponding to the identifiers, and the integrated audio file.

7. An electronic device, comprising:
at least one processor; and
a memory communicably connected with the at least one processor for storing instructions executable by the at least one processor, wherein execution of the instructions by the at least one processor causes the at least one processor to:
obtain an integrated live video stream according to a received resource address, wherein the integrated live video stream comprises at least two live video streams;
separate the integrated live video stream using a multistage parser into live video streams corresponding to identifiers one to one;
simultaneously play the live video streams corresponding to the identifiers.

8. The electronic device according to claim 7, wherein separate the integrated live video stream using a multistage parser into live video streams corresponding to identifiers one to one comprises:
separate the integrated live video stream using the multistage parser to obtain a plurality of video segments corresponding to different identifiers in sequence;
generate corresponding live video streams according to the video segments corresponding to the identifiers.

9. The electronic device according to claim 8, wherein separate the integrated live video stream using a multistage parser into live video streams corresponding to identifiers one to one comprises:
record sort order of the video segments;
merge the video segments corresponding to each identifier according to the sort order to generate the live video stream corresponding to the identifier.

10. The electronic device according to claim 8, wherein separate the integrated live video stream using a multistage parser into live video streams corresponding to identifiers one to one comprises:
separate the live video stream corresponding to each identifier according to file formats to obtain a video file and an audio file included in each live video stream.

11. The electronic device according to claim 9, wherein separate the integrated live video stream using a multistage parser into live video streams corresponding to identifiers one to one comprises:
separate the live video stream corresponding to each identifier according to file formats to obtain a video file and an audio file included in each live video stream.

12. The electronic device according to claim 10, wherein simultaneously play the live video streams corresponding to the identifiers comprises:
integrate the audio files of the live video streams corresponding to the identifiers to generate an integrated audio file;
simultaneously play the video files of the live video streams corresponding to the identifiers, and the integrated audio file.

13. A non-transitory computer-readable medium, storing executable instructions that, when executed by an electronic device, cause the electronic device to:
obtain an integrated live video stream according to a received resource address, wherein the integrated live video stream comprises at least two live video streams;
separate the integrated live video stream using a multistage parser into live video streams corresponding to identifiers one to one;
simultaneously play the live video streams corresponding to the identifiers.

14. The non-transitory computer-readable medium according to claim 13, wherein separate the integrated live video stream using a multistage parser into live video streams corresponding to identifiers one to one comprises:
separate the integrated live video stream using the multistage parser to obtain a plurality of video segments corresponding to different identifiers in sequence;
generate corresponding live video streams according to the video segments corresponding to the identifiers.

15. The non-transitory computer-readable medium according to claim 14, wherein separate the integrated live video stream using a multistage parser into live video streams corresponding to identifiers one to one comprises:
record sort order of the video segments;
merge the video segments corresponding to each identifier according to the sort order to generate the live video stream corresponding to the identifier.

16. The non-transitory computer-readable medium according to claim 14, wherein separate the integrated live video stream using a multistage parser into live video streams corresponding to identifiers one to one comprises:
separate the live video stream corresponding to each identifier according to file formats to obtain a video file and an audio file included in each live video stream.

17. The non-transitory computer-readable medium according to claim 15, wherein separate the integrated live video stream using a multistage parser into live video streams corresponding to identifiers one to one comprises:
separate the live video stream corresponding to each identifier according to file formats to obtain a video file and an audio file included in each live video stream.

18. The non-transitory computer-readable medium according to claim 16, wherein simultaneously play the live video streams corresponding to the identifiers comprises:
integrate the audio files of the live video streams corresponding to the identifiers to generate an integrated audio file;
simultaneously play the video files of the live video streams corresponding to the identifiers, and the integrated audio file.
